(19) United States
(12) Patent Application Publication
(10) Pub. No.: US 2011/0161005 A1
(43) Pub. Date: Jun. 30, 2011

(54) SYSTEMS AND METHODS FOR END-TO-END LOCATION AND MEDIA CONTENT TRACKING

(75) Inventors: Mahan Hajianpour, Glendale, CA (US); Jeffrey D. Lipeles, Redondo Beach, CA (US)

(73) Assignee: THE AEROSPACE CORPORATION, El Segundo, CA (US)

(21) Appl. No.: 12/650,602

(22) Filed: Dec. 31, 2009

(51) Int. Cl. G01C 21/00; G06F 15/16; G06F 17/30; H04N 5/76

(52) U.S. Cl. 701/207; 709/203; 707/812; 348/231.4; 707/E17.009; 348/E05.031

(57) ABSTRACT

Systems and methods may provide location and media content tracking. The systems and methods may include receiving, from a personal communications device, location information and at least one media content, the location information indicating one or more historical physical locations of the personal communications device, the at least one media content associated with at least one of the one or more physical locations of the personal communications device; storing an association among an identification of the personal communications device, the at least one media content, and the location information corresponding to the one or more physical locations associated with the at least one media content; receiving, from a client computer, a request to track the personal communications device; and responsive to the request, providing the at least one media content and the corresponding location information to the client computer.

### STATEMENT OF GOVERNMENT INTEREST

This invention was made with government support under contract 2005-IJ-CX-K030 awarded by the Department of Justice, Office of Justice Programs. The government has certain rights in the invention.

### FIELD OF THE INVENTION

Aspects of the invention relate generally to end-to-end location and media content tracking for personal communication devices and other mobile devices.

### BACKGROUND OF THE INVENTION

Most mobile phones provide the means to obtain location data from the phone. However, current applications for mobile phones do not provide an end-to-end solution in which a mobile device can provide tracking information to a server, which in turn can provide the tracking information to a map-based tracking application accessible by another end-user computer. Accordingly, there is a need in the industry for systems and methods for end-to-end location and media content tracking.

### SUMMARY OF THE INVENTION

According to an example embodiment of the invention, there is an asset-tracking system. The system may include a memory that stores computer-executable instructions, and a processor in communication with the memory. The processor may be configured to execute the computer-executable instructions to: receive, from a personal communications device, location information and at least one media content, the location information indicating one or more historical physical locations of the personal communications device, the at least one media content associated with at least one of the one or more physical locations of the personal communications device; store an association among an identification of the personal communications device, the at least one media content, and the location information corresponding to the one or more physical locations associated with the at least one media content; receive, from a client computer, a request to track the personal communications device; and responsive to the request, provide the at least one media content and the corresponding location information to the client computer.

According to another example embodiment of the invention, there is a computer-implemented asset-tracking method. The method may include receiving, from a personal communications device, location information and at least one media content, the location information indicating one or more historical physical locations of the personal communications device, the at least one media content associated with at least one of the one or more physical locations of the personal communications device; storing an association among an identification of the personal communications device, the at least one media content, and the location information corresponding to the one or more physical locations associated with the at least one media content; receiving, from a client computer, a request to track the personal communications device; and responsive to the request, providing the at least one media content and the corresponding location information to the client computer. The prior steps may be performed by one or more service provider computer systems comprising one or more computers.

### BRIEF DESCRIPTION OF THE DRAWINGS

Reference will now be made to the accompanying drawings, which are not necessarily drawn to scale, and wherein:

FIG. 1 illustrates an example location and media content tracking system, according to an example embodiment of the invention.

FIG. 2 is a block diagram representing example data flows of systems that may support example location and media content tracking, according to an example embodiment of the invention.

FIG. 3 illustrates a flow diagram for supporting example location and media content tracking, according to an example embodiment of the invention.

FIGS. 4A and 4B illustrate example graphical user interfaces utilized by an example personal communications device, according to example embodiments of the invention.

FIG. 5 illustrates an example graphical representation that illustrates the tracking of an example personal communications device, according to an example embodiment of the invention.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention provide systems and methods for end-to-end location and media content tracking Generally, one or more cellular phones, mobile devices, personal communications devices (hereinafter referred to interchangeably as “mobile devices”, “personal communication devices”, “mobile phones”, or “cellular phones”) are configured with one or more software applications to deliver tracking information and optionally, associated media content coupled to tracking information, to a backend service provider computer. The service provider computer may also receive requests from end users of other computers that wish to track the one or more personal communications devices, perhaps in real-time, and optionally, view or otherwise identify any associated media content captured by the personal communications devices.

The service provider computer is uniquely positioned to provide a low-cost and scalable solution, according to an example embodiment of the invention. Indeed, the service provider computer can be configured to operate with a variety of off-the-shelf personal communications devices. Likewise, the service provider computer can also communicate with end-users wishing to track the personal communications devices via a variety of personal or server computers or computing devices over one or more networks, including the Internet.

It will be appreciated that such an end-to-end location and media content tracking system may be utilized in a variety of real-world scenarios. For example, on-the-ground personnel or users could utilize the personal communications devices to take or generate pictures, video, voice recordings, text messages, or other media content at one or more locations, and the location information and associated media content can be provided to the service provider computer. Other personnel or users at a different location may review the location information and/or associated media content to receive tracking updates for the on-the-ground personnel, or to otherwise identify, analyze, or otherwise evaluate activity of interest at one or more locations. Appropriate action may be taken based upon the determination of any activity of interest at one or more locations. For example, law enforcement or military personnel or users may be able to assess and respond to a situation that is occurring in real-time. As another example, emergency medical personnel can be tracked at the scene of a disaster and be provided with resources and more personnel based on the situations at their relative locations. The system can also be used by civilians to provide an agency or municipality with location and media regarding an event or disaster that is happening. In yet another example, the system can also be utilized to generate a travel or vacation diary or log for one or more users.

System Overview

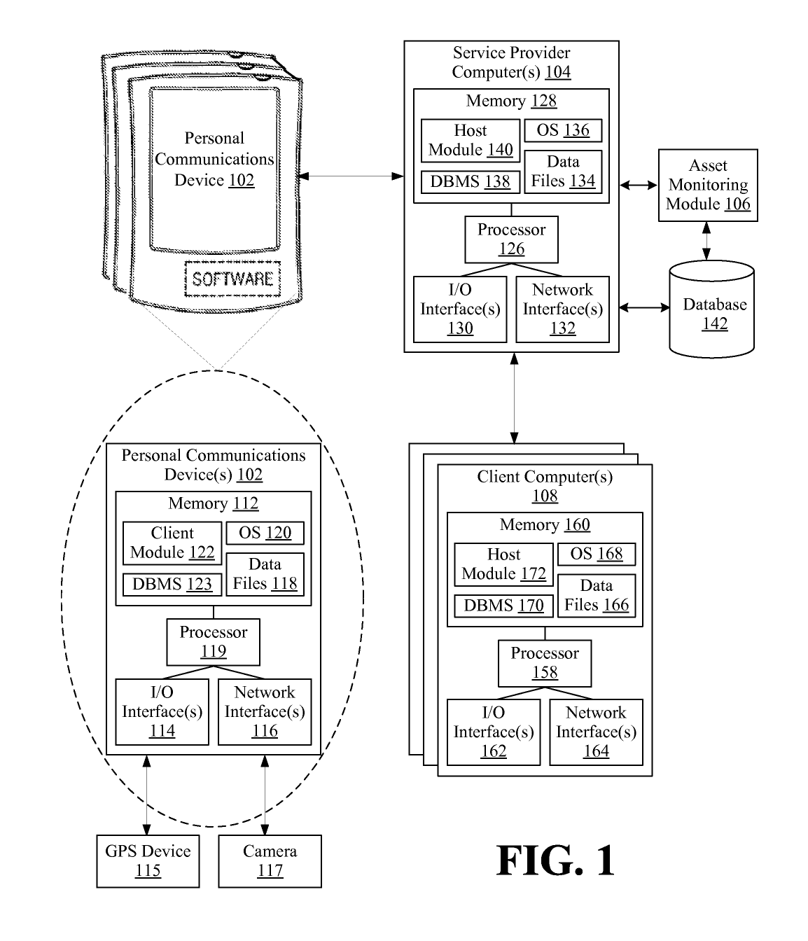

FIG. 1 illustrates an example location and media content tracking system 100, according to an example embodiment of the invention. The system 100 may include at least one personal communications device 102, at least one service provider computer 104, and at least one client computer 108, each configured for accessing and reading associated computer-readable media having stored thereon data and/or computer-executable instructions for implementing the various methods described herein. For each of the computers described herein, it is appreciated that various components and features of each of the computers may also be provided in multiples (e.g., multiple processors, memory elements, application modules, etc.), but may be referred to herein in the singular for simplicity.

The personal communications device 102 may be include a Blackberry mobile device, an Apple iPhone, an Apple iPod Touch (with Wi-Fi connectivity), a Microsoft Windows Mobile device, a Google Android mobile device, a cellular phone, a handheld computer or tablet, or any other processor-driven mobile communications device. In addition to having one or more processor(s) 119, the personal communications device 102 may further include one or more memories 112, one or more input/output (“I/O”) interfaces 114, and one or more network interfaces 116. The memory 112 may store data files 118 and various program modules, such as an operating system (“OS”) 121, a client module 122, and optionally a database management system (“DBMS”) 123 for accessing one or more databases. The I/O interface(s) 114 may facilitate communication between the processor 119, and various I/O devices, such as a keyboard, keypad, mouse, touch screen, microphone, speaker, bar code reader/scanner, RFID reader, and global positioning system (GPS) device 115, and camera 117. It will be appreciated that GPS device 115 and the camera 117 (e.g., picture camera and/or video camera) may either be integrated as part of the personal communications device 102 or otherwise provided externally to the personal communications device 102. If the GPS device 115 or the camera is provided externally to the personal communications device 102, then communications between the GPS device 115 or the camera 117 may be accomplished using a wired connection (e.g., a wired dongle) or a wireless connection (e.g., via Bluetooth, etc.). The network interfaces 116 may take any of a number of forms, such as a network interface device, a modem, a wireless network device, and the like.

Still referring to the personal communications device 102, the client module 122 may be a software program for obtaining location information and media content from the personal communications device 102 and delivering the obtained location information and media content to the service provider computer 104. The client module 122 may be a software program developed using a Java Development Environment (JDE), the Eclipse Integrated Development Environment (IDE), or another software development platform (e.g., from Microsoft, Apple, Google, etc.) compatible with the personal communications device 102. An on-the-ground user may utilize the client module 122 to configure the personal communications device 102 to deliver location information and/or media content to the service provider computer 104. The user may also utilize the client module 122 to obtain media content using the personal communications device 102. For example, the media content may be an image or video recording obtained by the camera 117 and/or a voice recording obtained by a microphone of the personal communications device 102. The client module 122 may also be utilized to retrieve or otherwise receive data from the service provider computer 104, as described herein.

The service provider computer 104 may be configured for interacting with the personal communications devices 102 and client computers 108 to support location and media content storage and tracking, according to an example embodiment of the invention. The service provider computer 104 may be a processor-driven device, such as, but not limited to, a server computer, a personal computer, a laptop computer, and the like. In addition to having one or more processors 126, the service provider computer 104 may include one or more memories 128, one or more input/output (“I/O”) interfaces 130, and one or more network interfaces 132. The memory 128 may store data files 134 and various program modules, such as an operating system (“OS”) 136, a host module 140, and a database management system (“DBMS”) 138 for accessing one or more databases such as database 142. The DBMS 138 may be a database engine provided by MySQL, Oracle, or another database provider. The database 142 may be a relational database, an objected-oriented database, or the like.

The I/O interface(s) 130 may facilitate communication between the processor(s) 126, respectively, and various I/O devices, such as a keyboard, mouse, printer, microphone, speaker, monitor, bar code reader/scanner, RFID reader, and the like. The network interface(s) 132 may take any of a number of forms, such as a network interface card, a modem, a wireless network card, and the like.

The host module 140 of the service provider computer 104 may initiate, receive, process, and respond to requests from the client module 122 of personal communications device 102, and may further initiate, receive, process, and respond to requests from the client module 172 of the client computer 108. The service provider computer 104 may communicate with, or otherwise include, an asset monitoring module 106, which may include computer-executable instructions operable to direct the storage and retrieval of information based upon requests and information received from the personal communications device 102 and/or client computer 108. As an example, the service provider computer 104 may utilize asset monitoring module 106 to store location information and media content corresponding to one or more personal communications devices 102 in one or both of a database 142 or in data files 142, as described herein. Likewise, the service provider computer 104 may utilize asset monitoring module 106 to retrieve location information and media content from one or both of the database 142 or the data files 142 for presentation or other delivery to one or more client computers 108.

In an example embodiment of the invention, the host module 140 and/or asset monitoring module 106 may comprise web server software, which may include but is not limited to Apache Tomcat. The web server software can support HTTP web server technology to serve basis data (e.g., pictures) to the Internet. However, the web server software can further support other modules and applications such as Java servlets for pushing and pulling data from the database 142 in conjunction with the DBMS 123.

It is appreciated that in example embodiments, the asset monitoring module 106 and/or the database 142 may be provided in part or entirely within the service provider computer 104. In yet other embodiments, the asset monitoring module 106 and/or the database 142 may be part of a stand-alone processor-based computer or otherwise provided in part or entirely within one or more of the other entities' systems, such as at the personal communications device 102 and/or at the client computer 108. If the service provider computer 104 includes the asset monitoring module 106 and/or the database 142, then the database 142 could also be part of the memory 128, and the asset monitoring module 106 can be stored in the memory 128.

Although a single database 142 is referred to herein for simplicity, it is appreciated that multiple physical and/or logical data storage devices or databases may be used to store the above mentioned data. For security and performance purposes, the service provider computer 104 and/or asset monitoring module 106 may have a dedicated connection to the database 142. However, the service provider computer 104 and/or asset monitoring module 106 may also communicate with the database 142 via a network, which may be a public network, a private network, the Internet, or a combination thereof. According to other embodiments, the service provider computer 104 may include the database 142 locally. The service provider computer 104 may also otherwise be part of a distributed or redundant DBMS.

The client computer 108 may be configured for communicating with the service provider computer 104 in order to receive location information and associated media content corresponding to one or more personal communications devices 102. The client computer 108 may be a processor-driven device, such as, but not limited to, a server computer, a personal computer, a laptop computer, a handheld computer or tablet, a personal communications device, and the like. In addition to having one or more processors 158, the client computer 108 may further include one or more memories 160, one or more input/output (“I/O”) interfaces 162, and one or more network interfaces 164. The memory 160 may store data files 166 and various program modules, such as an operating system (“OS”) 168, a client module 172, and a database management system (“DBMS”) 170 for accessing one or more databases. The I/O interface(s) 162 may facilitate communication between the processor(s) 158 and various I/O devices, such as a keyboard, mouse, printer, microphone, speaker, monitor, bar code reader/scanner, RFID reader, and the like. The network interface(s) 164 each may take any of a number of forms, such as a network interface card, a modem, a wireless network card, and the like.

In an example embodiment of the invention, the client module 172 may comprise a tracking application operable with or including an Internet browser and mapping software. The client module 172 may be operative to receive location information and media content from the service provider computer 104, and to present the received information in the Internet browser, perhaps in a graphical representation of a geographical map.

It is appreciated that each of the memories and data storage devices described herein for each of the personal communications device 102, the service provider computer 104, and the client computer 108 can store data and information for subsequent retrieval. The memories and data storage devices can be in communication with each other and/or other data storage devices, such as a centralized database, or other types of data storage devices. When needed, data or information stored in a memory or a data storage device may be transmitted to a centralized database capable of receiving data, information, or data records from more than one database or other data storage devices. In other embodiments, the data storage devices shown can be integrated or distributed into any number of databases or other data storage devices.

It is appreciated that the personal communications devices 102 and the client computers 108 may be in communication with the service provider computer 104 via one or more networks. As an example, the personal communications devices 102 may communicate with the service provider computer 104 via one or more cellular networks (e.g., Verizon, AT&T, Clear, Sprint, Nextel, etc.) through one or more mobile telephony communications protocols such as 3G, 4G, Edge, High-Speed Downlink Packet Access, General packet radio service (GPRS), and the like. Alternatively, the personal communications devices 102 may communicate with the service provider computer 104 via one or more wireless networks, including Wi-Fi or other IEEE 802.XX networks. The cellular or wireless networks also support transfer of information via Internet-based protocols or other packet switching protocols or file transfer protocols. These network(s) may also allow for real-time, off-line, and/or batch information (e.g., location information, media content, etc.) to be transmitted from the personal communications device 102 and the service provider computer 104.

Similarly, the client computers 108 may be in communication with the service provider computer 104 via one or more networks, which may include any number of telecommunication and/or data networks, whether public, private, or a combination thereof, including a local area network, a wide area network, a publicly switched telephone network (“PSTN”), an intranet, the Internet, and/or any combination thereof and may be wired and/or wireless. These network(s) may also allow for real-time, off-line, and/or batch transactions to be transmitted between the service provider computer 104 and the client computer 108. Due to network connectivity, various methodologies as described herein may be practiced in the context of distributed computing environments.

The system 100 shown in and described with respect to FIG. 1 is provided by way of example only. Numerous other operating environments, system architectures, and device configurations are possible. Accordingly, embodiments of the invention should not be construed as being limited to any particular operating environment, system architecture, or device configuration.

Operational Overview

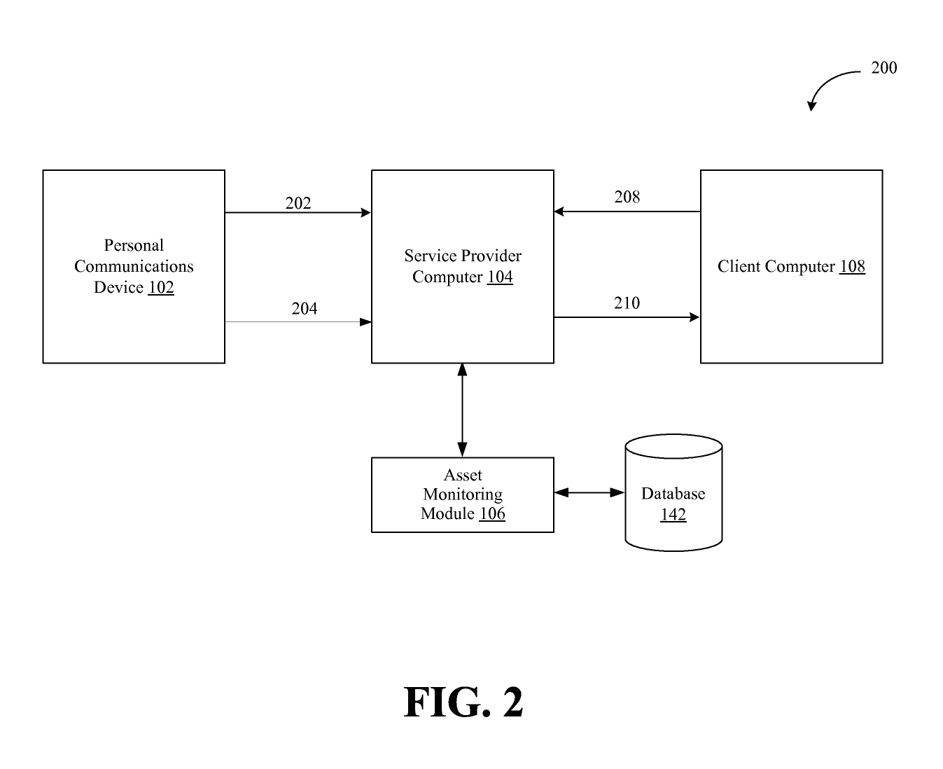

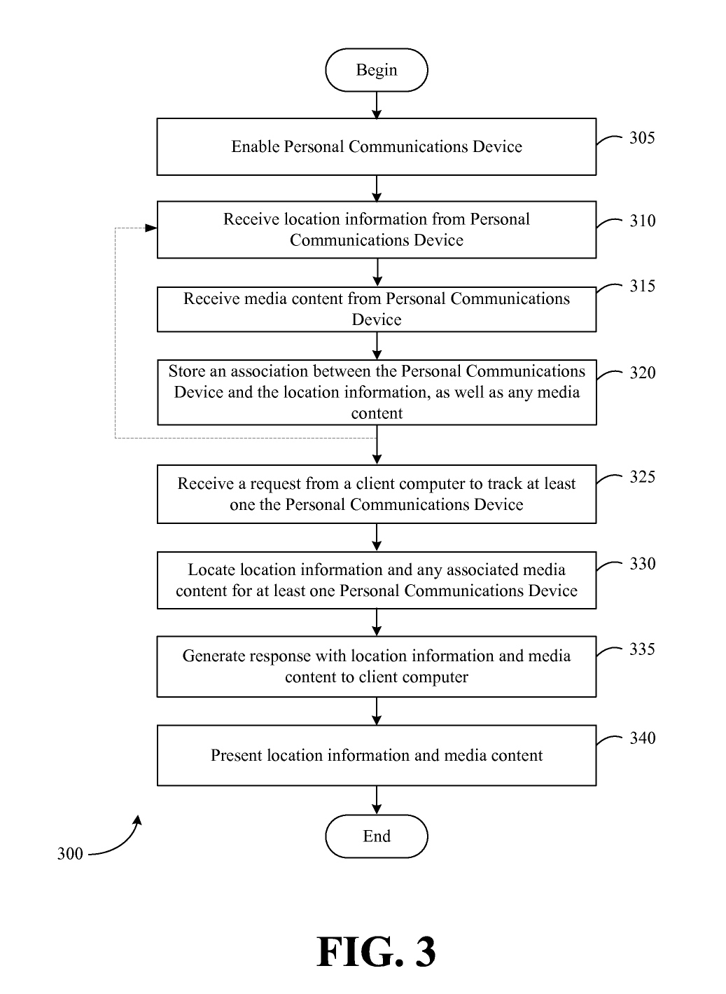

FIG. 2 is a block diagram representing example data flows of systems that may support example location and media content tracking, according to an example embodiment of the invention. The data flows of and system relationships represented in the block diagram of FIG. 2 will be discussed in conjunction with the flow diagram of FIG. 3.

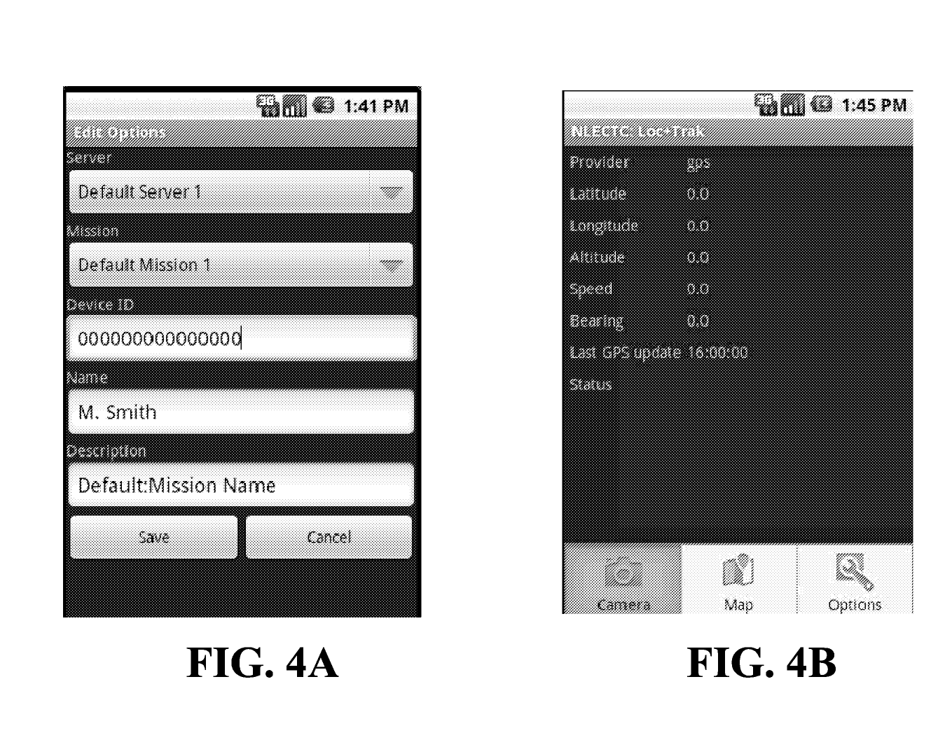

Referring now to FIGS. 2 and 3, at block 305, a user may activate client module 122 on the personal communications device 102 to activate or enable software for location information and media content tracking for the personal communications device 102. The software may be generally operative to perform the following tasks: (i) tracking the current location of the personal communications device 102, (ii) generating media content using one or more devices (e.g., camera 117, microphone, etc.) of the personal communications device 102, and (iii) reporting or transmitting location information and media content data to the service provider computer 104. As part of activation of the block 305, the personal communications device 102 may connect to the service provider computer 104, perhaps using hypertext transfer protocol (HTTP) for the communications, to specify one or more configuration options. Either before or after connecting to the service provider computer 104, the personal communications device 102 may present a graphical user interface for setting adjustable configuration options, which will be received by the service provider computer 104. An example of such a graphical user interface is illustrated in FIG. 4A. As shown in FIG. 4A, the user can specify or otherwise provide, via the graphical user interface, one or more of the following configuration options:

Server name: A name or identification of the server that will be receiving the location information and/or media content.

Mission name: A name or identification of a particular mission or purpose. Different missions may be used to keep track of different groups of personal communications devices 102 or for different tasks/purposes. As an example, a single personal communications device 102 may be part of a mission with other personal communications devices. Alternatively, a single personal communications device 102 could simply be used for two or more different tasks/purposes.

Device ID: A unique ID for the personal communications device 102. As an example, the unique ID may be a phone number, network ID, or alphanumeric ID assigned to the personal communications device.

Device Name: A human-readable device name (e.g., M. Smith). The device name may be selected to be easily recognizable to other users.

Device Description: A human-readable description of the device, which is typically more descriptive than the Name or Device ID. The Device Description may be used to, for example, to provide more insight regarding the specialty that the user or carrier of the personal communications device 102 may have (e.g. Paramedic, Police Officer, etc.).

Still referring to block 305, the user may also be able to set additional options via a user interface of the personal communications device 102, including selecting the frequency with which location information is to be provided to the service provider computer 104. As an example, the location information may be provided periodically to the service provider computer 104, perhaps every 10 seconds, 30 seconds, 1 minute, 3 minutes, 5 minutes, 10 minutes, 15 minutes, etc. Indeed any frequency interval, including irregular intervals or batch or queued transmissions for non-real-time delivery may be utilized, according to example embodiments of the invention. Likewise, the user may also select which devices (e.g., camera 117, microphone, etc.) can be used to generate media content for the personal communications device 102. Similarly, if there is more than one GPS device 115 available, the user can select which GPS device 115 to utilize for obtaining the location information. It is appreciated that many other options related to location information and media content tracking can be set or configured by the user without departing from example embodiments of the invention. In an example embodiment of the invention, the software of the personal communications device 102 maintains an open communications link or session with service provider computer 104 until the software is deactivated, stopped, or disabled.

At block 310, the personal communications device 102 may provide location information 202 to the service provider computer 104. It is appreciated that the location information 202 may be delivered according to the frequency or schedule configured by the software at block 305. The location information 202 may comprise GPS coordinates from the selected GPS device 115 of the personal communications device 102. As shown by the user interface of the personal communications device 102 in FIG. 4B, these GPS coordinates can include latitude and longitude coordinates. However, the location information 202 may also include altitude, speed, and/or bearing information as well without departing from an example embodiment of the invention. Alternatively, the location information 202 could otherwise include street names, street addresses, or location names, according to an example embodiment of the invention. In any event, at block 310, the service provider computer 104 may receive location information 202 from the personal communications device 102.

At block 315, the user of the personal communications device 105 may also choose to generate media content 204 at the location of the personal communications device 105. As an example, the user may utilize the enabled software and the camera 117 of the personal communications device 102 to take a picture or a video recording of a person, item, object, and/or background of interest. For instance, the picture or video may be of a person, a particular landmark of interest, potential evidence, inspection pictures, etc. Additionally, or alternatively, the user can also use the enabled software and microphone of the personal communications device 102 to record once or more sounds or noises of interest. As an example, the user may take one or more verbal notes, or otherwise record one or more sounds or noises (e.g., conversations of another or background sounds or noises). As another example, the user can also use a keyboard, keypad, or touchpad of the personal communications device 102 to generate one or more text messages or Internet messages. It will be appreciated that other media content may also be obtained without departing from example embodiments of the invention.

These and other media content 204 generated by the application at block 315 can also be tagged with location information. In an example embodiment of the invention, the file having the media content can be generated with metadata that specifies the location information (e.g., GPS coordinates). In this way, the location corresponding to the generated media content (e.g., the location where the picture, video, voice recording, or text message was taken/generated). It is appreciated that the location information can alternatively be embedded within the media content apart from the metadata as well without departing from example embodiments of the invention. For example, the location information can be overlaid to form part of a displayed portion of an image or picture. At block 315, the personal communications device 102 may transmit the generated media content 204 to the service provider computer 104, perhaps in accordance with an HTTP protocol. Thus, the service provider computer may receive the media content 204.

It is appreciated that the location information 202 may be provided on a periodic basis while the media content 204 may be provided on an as-generated basis. However, the media content 204 may also be delivered with the location information 202 without departing from example embodiments of the invention.

Following block 315 is block 320. At block 320, the service provider computer 104 may receive the location information 202 from block 310 as well as the media content 204 from block 315. The service provider computer 104, perhaps by executing the asset monitoring module 106, may store the received location information 202 and media content 204 in the database 142 and/or data files 134 for later retrieval and storage. Table I below illustrates example records that may be stored in the database 142 related to the location information 202 and the media content. More specifically, as the location information 202 is received, perhaps periodically, at block 310, the service provider computer 104 and/or asset monitoring module 202 creates a corresponding record in the database 142 with the date, time, and received location information 202. While not illustrated, in Table I, an example record in the database 142 may also indicate one or more of the mission name, device ID, device name, device description, and/or device description, as selected or configured at block 305.

In addition, one or more media content 204 may be received by the service provider computer 104. Where the media content 204 is received with the location information 202, the service provider computer 104 and/or asset monitoring module 106 may store the media content 204, and optionally a sample or reduced version (e.g., thumbnail version, stream-lined version etc.) of the media content 204, as part of data files and/or another file repository (e.g., in a predetermined directory structure). The service provider and/or asset monitoring module 106 may then store, in the database, a reference to the file name for the media content in the record having the corresponding location information 202. However, it will be appreciated that in some instances, the media content 204 may be received apart from the location information 202. If the location information and media content 204 are being provided in real-time, then the reference to the media content 204 may be stored with the latest or most recent record entry in the database 142 since the last entry. Alternatively, if the location information and media content 204 are not being provided in real-time, then the time associated with media content 204 (e.g., time of file creation, time of receipt of media content by service provider computer 104, etc.) was generated may be used to determine which record entry in the database 124 has a time closest to the time that the media content 204 was generated. It will be appreciated that the database 142 can alternatively also store the actual media content 204 instead of the references without departing from example embodiments of the invention.

TABLE I

| | | | Reference to |
|---|---|---|---|
| | | Location | Media |
| Date | Time | Information | Content |
| MM/DD/YYYY | 13:00.00 | GPS | URL or |
| | | Coordinates #1 | File Name #1 |
| MM/DD/YYYY | 13:01.30 | GPS | [No Media |
| | | Coordinates #2 | Content] |
| . . . | . . . | . . . | . . . |
| MM/DD/YYYY | 15:00.00 | GPS | URL or |
| | | Coordinates #n | File Name #2 |

It will be appreciated that one or more of blocks 310, 315, and 320 may be repeated as necessary to update database 142 and data files 134 with updated location information and newly generated media content. Indeed, a user may utilize the personal communications device 102 to provide a plurality of location information 202 associated with the user's movements with the personal communications device 102. Likewise, the user may decide to utilize the personal communications device 102 to generate one or more additional media content, according to an example embodiment of the invention.

In generating or storing the records in database 142, the service provider computer 104 may access, perhaps from the host module 140 or asset monitoring module 106, one or more Java servlets or other specialized processing modules for data control and verification to control the flow of data into and from the database 142 and/or data files 134. Indeed, the servlets or other specialized processing modules may perform various tasks such as data validation, data calculation, and media content manipulation (e.g., image header manipulation) in addition to interacting with the stored procedures to add and manipulate data for storage in database 142 and/or data files 134. For example, an example servlet or other specialized processing module that stores media content 204 and its associated location information 202 can verify that the location information 202 is correctly formatted and can perform predetermined processing (e.g., create a thumbnail for an image, add the location to the image's header) prior to invoking one or more procedure calls to store the location information 202 and media content 204 in database 142 and/or data files 134.

In an example embodiment of the invention, the example servlets or specialized processing modules may use standard protocols to send and receive data, although they also can utilize proprietary protocols as well. To receive data, the servlets may support both the HTTP POST and HTTP GET methods, according to an example embodiment of the invention. To send data, the servlets may output standard, schema-backed extensible markup language (XML), according to an example embodiment of the invention. Example schemas utilized for XML at least include a device name, a device description, and related location information, which may include, but is not limited to the following: latitude, longitude, altitude, heading, and/or speed. This example approach may allow the servlets or specialized processing modules to be utilized not only at the service provider computer 104, but also for the personal communications device 102 and the client computer 108. For example, the same or similar servlets or specialized processing modules can be used at the personal communications device 102 for pushing location information or media content to the service provider computer 104. Likewise, the same or similar servlets or specialized processing modules can be used by the client computer 108 to fetch data for display by the tracking application of the client computer 108.

It is further appreciated that the service provider computer 104 employing a web services-style architecture may allow for access and integration by other devices besides the personal communications device 102 and the client computer 108. Because the example data receiving servlets receive data using the HTTP protocols, another authorized device simply needs to know the proper parameters to send data to service provider computer 104. Similarly, because the data fetching servlets may use schema-backed XML, an authorized user device with knowledge of the schema can easily parse the fetched data. In addition, because of the wide use of XML technologies, many open-source libraries and technologies exist for handling XML, allowing the XML to be handled by most existing and future technologies.

Following block 320 is block 325. At block 325, another user using a client computer 108 may wish to track at least one personal communications device 102. To do so, the user may utilize a client computer 108 to send a request 208 to the service provider computer 208. The request 208 may identify, for example, a particular mission to be tracked and/or one or more personal communication devices 208 to be tracked. It will be appreciated that the request 208 may be provided from a web-based tracking application utilizing an Internet browser of the client computer 108. In an example embodiment of the invention, the web-based tracking application comprise a Java servlet or other specialized processing module to provide the request 208 as an HTTP request, although other networking protocols may be utilized as well.

At block 330, the service provider computer 104, perhaps in conjunction with executing the asset monitoring module 106, may process the request 208 to determine which personal communications devices 102 are to be tracked. To do so, identification of the mission and/or one or more personal communications devices 102 (e.g., ID, name, etc.) may be used to obtain corresponding location information and/or media content from the database 142 or data files 134. In an example embodiment of the invention, the service provider computer 104 and/or asset monitoring module 106 may provide the identification of the mission and/or personal communications device 102 to a data serving servlet. If a mission is identified, location information and/or media content for the personal communications devices 102 that are associated with the mission can be obtained. Alternatively, if a particular communications device 102 is identified, then the location information and/or media content for that particular communications device is obtained. It will be appreciated that the data serving servlet may access the database 142 using a Java Database Connectivity (JDBC) API, according to an example embodiment of the invention. The JDBC API may allow for the use of basic, non-database dependent structured query language (SQL) statements (e.g., stored procedure calls) and Java methods to communicate with the database 142 to obtain the location information and/or media content (or reference to the media content), according to an example embodiment of the invention.

At block 335, the service provider computer 104 and/or asset monitoring module 106 can generate a response 210 for delivery to the client computer 108. The response 210 may be in the form of an HTTP response in conjunction with an XML string, although other formats may be utilized without departing from example embodiments of the invention. The response 210 may include the obtained location information and if available, the media content or a reduced version or sample of the media content (e.g., a thumbnail of the image), for each identified personal communications device 102 that is to be tracked.

According to an example embodiment of the invention, the service provider computer 104 and/or asset monitoring module 106 can convert the obtained location information into an XML string or other format for inclusion with the response 210. To do so, a servlet can utilize the Java Architecture for XML Binding (JAXB) in the Java Web Services Developer Pack, according to an example embodiment of the invention. JAXB can generate Java objects based on a schema that allows these objects to be converted into XML. The servlet provides the location information into JAXB-generated Java objects, and JAXB can convert the objects into XML. To include location-based media content (e.g. images), a servlet may utilize the Java Advanced Imaging Image I/O Tools (JAI-Image I/O) API. The JAI-Image I/O Tools API may allow for the creation of a reduced version of the media content, as well as add location data to the media content's header. For example, for an image, the location data can be included in the image's Exchangeable Image File Format (EXIF) headers. The JAI-Image I/O API allows access to the image at the bit level so the headers can be extracted and the location data written to them.

Following block 335, processing may proceed to block 340. At block 340, the response 330 may be provided to the client computer 108. The response 330 may include the location information and the media content (or a reduced version of the media content) for each personal communications device 102 that is to be tracked by the client computer 108.

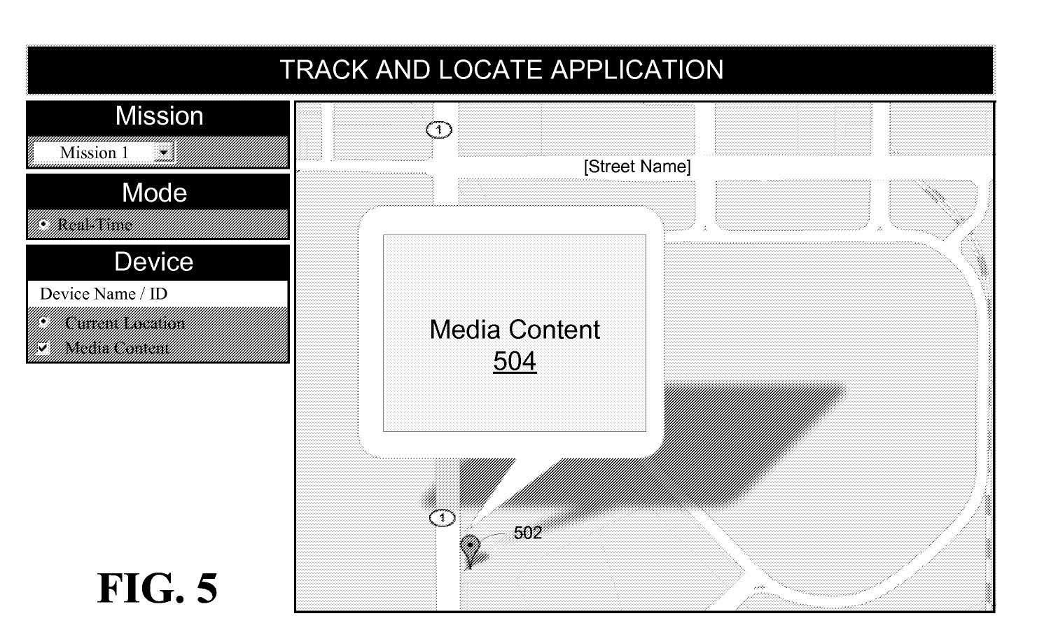

The client computer 108 may include a tracking application (e.g., client module 172) to present the location information and/or media content (or a reduced version of the media content), perhaps in a graphical representation to the user of the client computer 108. FIG. 5 illustrates an example graphical representation that illustrates tracking of a personal communication device 102 for a particular mission. As shown in FIG. 5, there may be a single personal communications device 102 (having a corresponding Device Name/ID) that is illustrated on a geographical map. The location of the personal communications device 102 may be represented by an indicator 502, and the media content 504 associated with that location may be available for viewing or downloading, according to an example embodiment of the invention. While FIG. 5 illustrates only a single personal communication device 102, there may be multiple communications devices without departing from example embodiments of the invention.

According to an example embodiment of the invention, to render a geographical representation such as that shown in FIG. 5, an example tracking application utilized by the client computer 108 may utilize a combination of HTML, mapping software (e.g., Google Maps, Yahoo! Maps, etc.), JavaScript, and Java servlet calls (through Asynchronous JavaScript and XML (AJAX)) to present a real-time look at the locations of and images from different personal communications devices 102 providing tracking data (e.g., location information and any media content) to the service provider computer 104. It will be appreciated that that tracking application of the service provider computer 104 can locally perform most of the processing needed for rendering the geographical representation for display to the user. However, in alternative embodiments of the invention, the service provider computer 104 could alternatively perform the majority of the processing, with the client computer 108 performing minimal processing to render the geographical representation for display.

In an example embodiment of the invention, the tracking application can use JavaScript to operate and track changes to the geographical representation (e.g., including updates for the location and availability of media content of the tracked personal communications devices 102. Indeed, asynchronous JavaScript and XML (AJAX) is a combination of technologies that may allow a client-side Internet browser application to make requests to the service provider computer 104, obtain results and display them without having to reload the tracking application. The tracking application can be comprised of one or more of the following four modules: (i) flow control, (ii) GUI control, (iii) map control, and (iv) data handling, according to an example embodiment of the invention.

The flow control module may include functions that the user-initiated actions (from the GUI) call to run the application. The user-initiated actions may be called through flow control, thereby minimizing or eliminating direct calls that need to be made to the other parts of the system. The GUI control module may keep track of the status of the GUI and contains functions that change the GUI depending on the status and actions of the system. This ranges from system dependent statuses like knowing what the selected mission is and changing the displayed indications to correspond to the selected mission's personal communications device 102, to purely superficial display information such as knowing a checkbox is checked and needs to be unchecked when a different action is undertaken.

The map control module may keep track of everything that is currently on the map of the GUI and contains all functions that interact with the mapping software. It will be appreciated that a variety of information can be configured for availability on the map. The map control module, however, generally facilitates allowing easy access to any location indication, media content, path or window that has been added to the map.

The data handling module may contain the AJAX code that calls the servlets and the XML parsing that converts the servlet-generated XML into JavaScript objects for use with the rest of the system. The servlet-generated XML may be bound by an XML schema and the parsing methods and the JavaScript objects are built based on the schema.

The process of FIG. 3 completes following block 340. It will be appreciated that while an example method has been illustrated in FIG. 3, other example methods may have alternative flows or alternative blocks without departing from example embodiments of the invention. Likewise, while example embodiments of the invention have been illustratively described with respect to HTTP, Java, and XML, it will be appreciated that many other protocols and programming languages can be utilized without departing from example embodiments of the invention. For example, other protocols and/or programming languages that can be utilized may include, but are not limited to, the use of any of the following: (i) TCP/IP or other protocols to relay information to the server, (ii) programming languages such as PHP, Python, C, C++, and variations thereof including, Ruby, Ruby on Rails, Perl, etc., (iii) Microsoft technologies such as ASP .net and C#, etc., and/or (iv) Apple technologies such as Objective-C and Apple's respective Coca SDK.

Various block and/or flow diagrams of systems, methods, apparatuses, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An asset-tracking system, comprising:
a memory that stores computer-executable instructions; and
a processor in communication with the memory, wherein the processor is configured to execute the computer-executable instructions to:
receive, from a personal communications device, location information and at least one media content, the location information indicating one or more historical physical locations of the personal communications device, the at least one media content associated with at least one of the one or more physical locations of the personal communications device;
store an association among an identification of the personal communications device, the at least one media content, and the location information corresponding to the one or more physical locations associated with the at least one media content;
receive, from a client computer, a request to track the personal communications device; and
responsive to the request, provide the at least one media content and the corresponding location information to the client computer.

2. The system of claim 1, wherein the at least one media content is generated by the personal communications device with the corresponding location information embedded within the at least one media content.

3. The system of claim 1, wherein the location information is periodically received from the personal communications device over a period of time, wherein when the at least one media content is received from the personal communications device, the processor is configured to:
determine the respective location information received nearest to a time associated with the least one media content,
wherein the determined location information is stored in an association with the identification of the personal communications device and the at least one media content.

4. The system of claim 3, wherein the time associated with the at least one media content is either a (i) first time in which the at least one media content is generated, or (ii) a second time in which the at least one media content is received from the personal communications device.

5. The system of claim 1, wherein the processor is configured to store an association among an identification of the personal communications device, the at least one media content, and the location information by:
storing the at least one media content as at least one file in a file repository, each media content associated with a respective link to the respective media content in the file repository; and
storing, in a database for each media content, the identification of the personal communications, the respective link to the respective media content, and the respective corresponding location information.

6. The system of claim 1, wherein the location information comprises global positioning system (GPS) coordinates from a GPS device coupled to the personal communications device.

7. The system of claim 6, wherein the GPS device is integrated with the personal communications device.

8. The system of claim 1, where the at least one media content comprises at least one of (i) a picture or (ii) a video, wherein the personal communications device is coupled to a camera for generating the picture or the video.

9. The system of claim 8, wherein the camera is integrated with the personal communication device or provided externally to the personal communications device.

10. The system of claim 1, wherein the at least one media content comprises at least one voice recording, wherein the personal communications device is coupled to a microphone for generating the at least one voice recording.

11. The system of claim 10, wherein the microphone is integrated with the personal communications device or provided externally to the personal communications device.

12. The system of claim 1, wherein the personal communications device comprises a cellular phone or a personal digital assistant (PDA).

13. The system of claim 1, wherein the processor is configured to provide the at least one media content and the corresponding location information to the client computer by:
enabling the presentation of one or more first visual indications associated with the corresponding location information on a geographical map, wherein at least one of the one or more first visual indications is presented in conjunction with the at least one media content or a respective link to the at least one media content.

14. A computer-implemented asset-tracking method, comprising:
receiving, from a personal communications device, location information and at least one media content, the location information indicating one or more historical physical locations of the personal communications device, the at least one media content associated with at least one of the one or more physical locations of the personal communications device;
storing an association among an identification of the personal communications device, the at least one media content, and the location information corresponding to the one or more physical locations associated with the at least one media content;
receiving, from a client computer, a request to track the personal communications device; and
responsive to the request, providing the at least one media content and the corresponding location information to the client computer,
wherein the prior steps are performed by one or more service provider computer systems comprising one or more computers.

15. The method of claim 14, wherein the at least one media content is generated by the personal communications device with the corresponding location information embedded within the at least one media content.

16. The method of claim 14, wherein the location information is periodically received from the personal communications device over a period of time, wherein when the at least one media content is received from the personal communications device, and further comprising:
determining the respective location information received nearest to a time associated with the at least one media content,
wherein the determined location information is stored in an association with the identification of the personal communications device and the at least one media content,
wherein the prior step is performed by one or more service provider computer systems comprising one or more computers.

17. The method of claim 16, wherein the time associated with the at least one media content is either a (i) first time in which the at least one media content is generated, or (ii) a second time in which the at least one media content is received from the personal communications device.

18. The method of claim 14, wherein the location information comprises global positioning system (GPS) coordinates from a GPS device coupled to the personal communications device.

19. The method of claim 14, where the at least one media content comprises at least one of (i) a picture or (ii) a video, wherein the personal communications device is coupled to a camera for generating the picture or the video.

20. The method of claim 14, providing the at least one media content and the corresponding location information to the client computer comprises providing a geographical map having one or more first visual indications on the map associated with the corresponding location information, wherein at least one of the one or more first visual indications is presented in conjunction with the at least one media content or a respective link to the at least one media content.
